(19) United States
(12) Patent Application Publication
(10) Pub. No.: US 2006/0044777 A1
(43) Pub. Date: Mar. 2, 2006

(54) Spotlight

(76) Inventor: Thomas Dorner, Kolbermoor (DE)

Correspondence Address: CHRISTIE, PARKER & HALE, LLP, PO BOX 7068, PASADENA, CA, 91109-7068, US

(21) Appl. No.: 10/528,502

(22) PCT Filed: Mar. 31, 2003
(86) PCT No.: PCT/DE03/01116

§ 371 Date: Aug. 1, 2005

(30) Foreign Application Priority Data
Sep. 20, 2002 (DE) 202 14 874.2

(51) Int. Cl. G03B 15/02

(52) U.S. Cl. 362/3

(57) ABSTRACT

The invention relates to a projector, particularly a stage projector, studio projector, film projector, and/or television projector, comprising a light source and a projector housing that surrounds the light source and is provided with a translucent covering element. At least one wall of the inventive projector housing comprises a ventilation shaft with separate ventilation ducts.

The invention relates to a spotlight, more particularly a stage, studio, film or television spotlight according to the preamble of claim 1.

Spotlights of this kind have a single or double socket light source which is mounted in a spotlight housing and consists of a bulb or burner, by way of example a discharge lamp in the form of a halogen metal vapour lamp or a sodium high pressure vapour lamp or the like which by means of a reflector likewise mounted in the spotlight housing radiates light out from an opening in the spotlight housing. In order to protect the light source and/or to shape the reflected light the spotlight housing is thereby closed at the front by a preferably transparent cover element in the form of a protective disc or lens held in a frame or socket.

Apart from the reflection of the light portions which are visible to the human eye non-visible heat radiation is also emitted in the infra-red spectral range which has to be dissipated in order to prevent overheating of the component parts mounted inside the spotlight housing such as light source, reflector, light source socket and supply leads. In order to ensure that the light rays emitted from the light source emerge substantially only through the light permeable cover element at the front, openings in the housing for discharging the heat which builds up inside the spotlight housing are undesirable. A heat flow is therefore substantially only possible through a corresponding enlarged surface area of the spotlight housing which is made up for example of cast aluminium parts and extruded aluminium profiles, which is effected through corresponding cooling ribs protruding from the contour of the spotlight housing. However an enlarged surface area of the spotlight housing achieved in this way leads to an enlargement of the spotlight as a whole and thus prevents the compact structural form of the spotlight, more particularly a high-powered spot light.

Fans fitted in order to discharge the heat load are in many cases undesirable because of the noises associated therewith.

The object of the present invention is therefore to provide a spotlight, even one with a high light intensity, which has a compact structural form and which discharges the heat radiation coming from the light source of the spotlight without emitting light to the surroundings of the spotlight away from the front side.

This is achieved according to the invention through the features of claim 1.

The solution according to the invention provides a spotlight which even with a high light output and thus associated high heat emissions from the light source of the spotlight has an extremely compact structural form and dissipates the heat radiation coming from the light source without any noise and without undesired light emerging from the spotlight housing.

The solution according to the invention is based on the idea of dissipating the heat radiation emitted from the light source of the spotlight through an intensified cooling air supply through convection. By discharging the incoming cooling air to different regions inside the spotlight housing it is possible to direct the cooling air to targeted areas so that a local build up of heat cannot arise and the cooling air flow is guaranteed to produce a uniform heat discharge.

The ventilation shaft can optionally be integrated in the housing wall of the spotlight housing, inserted in an opening in the housing wall of the spotlight housing or can be fitted on an opening of the housing wall of the spotlight housing and connected to the housing wall.

In the same way the ventilation shaft can have an air outlet aperture opening into one or more apertures in the wall of the spotlight housing, and an air inlet aperture protruding away from the wall of the spotlight housing or can be inserted in the wall of the spotlight housing so that the air inlet aperture protrudes from the wall of the spotlight housing and the air outlet aperture projects into the inside of the spotlight housing or can be integrated into the wall of the spotlight housing so that the air inlet aperture closes substantially flush with the housing wall and the air outlet aperture is arranged in the inside of the spotlight housing.

More particularly a combination of all three arrangements of the ventilation shaft is suitable for the controlled optimum heat discharge from the inside of the spotlight housing whereby different structural forms or arrangements of the ventilation shaft can best be used for the different housing walls.

The ventilation shafts preferably contain several ventilation ducts which are separated from each other by ribs.

The design of several ventilation ducts separated from each other by ribs enables on the one hand a controlled supply of cooling air to the individual regions inside the spotlight housing and on the other a highly effective light barrier which blocks wandering light from emerging from the inside of the spotlight housing. This action is intensified through a corresponding choice of material and through the shape and colouring of the ribs which can be in particular black and made from a strong light absorbing material.

Consequently the ribs are designed and arranged in the ventilation shaft so that the cooling air supplied through the ventilation shaft is active in different regions inside the spotlight housing.

The ribs are preferably arranged at substantially regular intervals from each other and from the wall of the ventilation shaft and have inside the ventilation shaft at least one bent or deflected area.

By arranging the ribs at regular intervals relative to each other and to the wall of the ventilation shaft a uniform cooling air supply is guaranteed whilst the bent or deflection area of the ribs inside the ventilation shaft offers increased protection from undesired light emerging from inside the spotlight housing since the light beams are repeatedly reflected and absorbed at the light-absorbing faces of the ribs.

In a first embodiment the ribs are arranged on one side of the air inlet aperture and/or air outlet aperture perpendicular to the air inlet aperture and/or air outlet aperture.

In a second embodiment the ribs at the side of the air inlet aperture and/or air outlet aperture are arranged at an angle to the air inlet aperture or air outlet aperture.

Furthermore the ribs at the air outlet aperture can have an air guide plate projecting beyond the air outlet aperture to serve as a flow guide for the cooling air.

Depending on the heat load which arises, the spotlight power and the structural form of the spotlight housing ventilation shafts can be arranged on both side walls and/or on the front and back side wall and/or on the underneath of the spotlight housing.

With a ventilation shaft arranged on the underneath of the spotlight housing the air outlet aperture opens directly adjacent the light source or light source socket into the inside of the spotlight housing.

With this arrangement of the ventilation shaft a highly effective air flow is generated at the side face of the light source inside the spotlight housing whereby the cooling air is directed fan-like round the light source.

The idea on which the invention is based will now be explained in further detail with reference to the embodiment shown in the drawings. In the drawings:

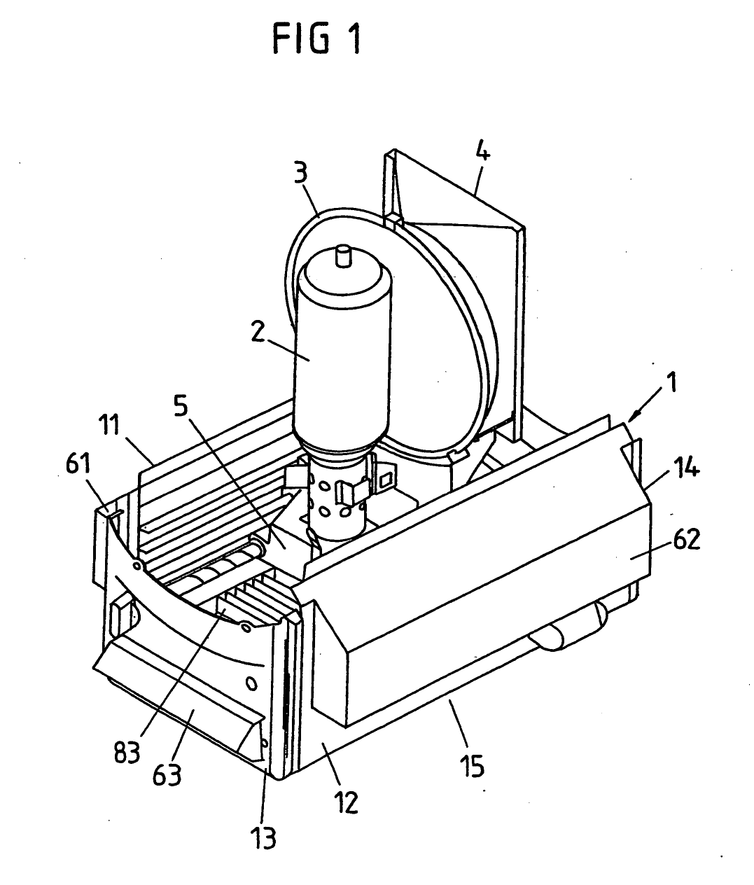

FIG. 1 shows a perspective view of a compact spotlight with a part of the light source housing and several ventilation shafts;

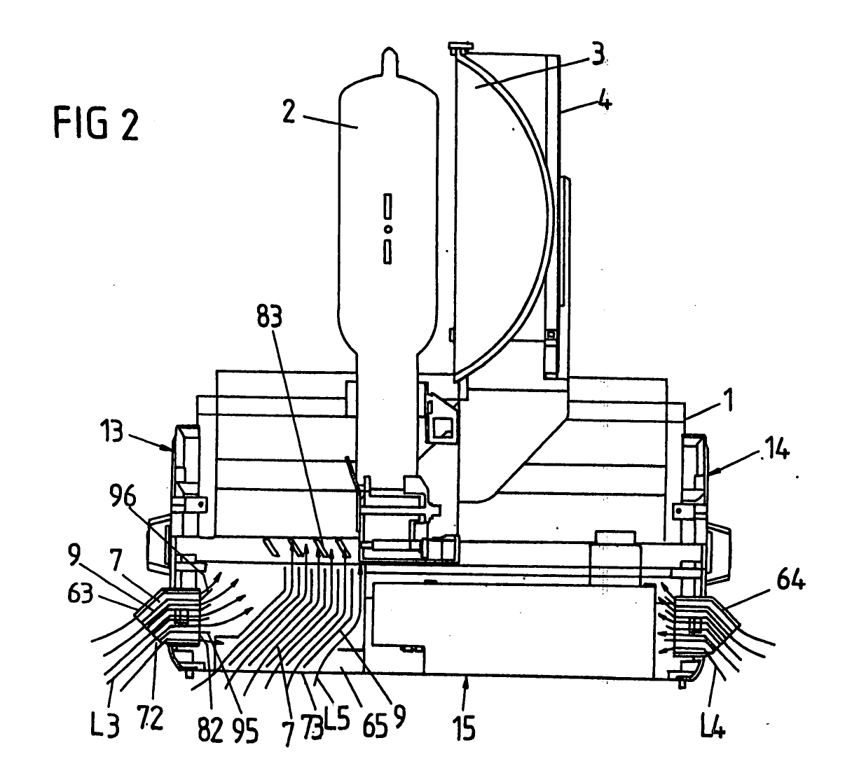

FIG. 2 shows a longitudinal section through the spotlight housing according to FIG. 1 and

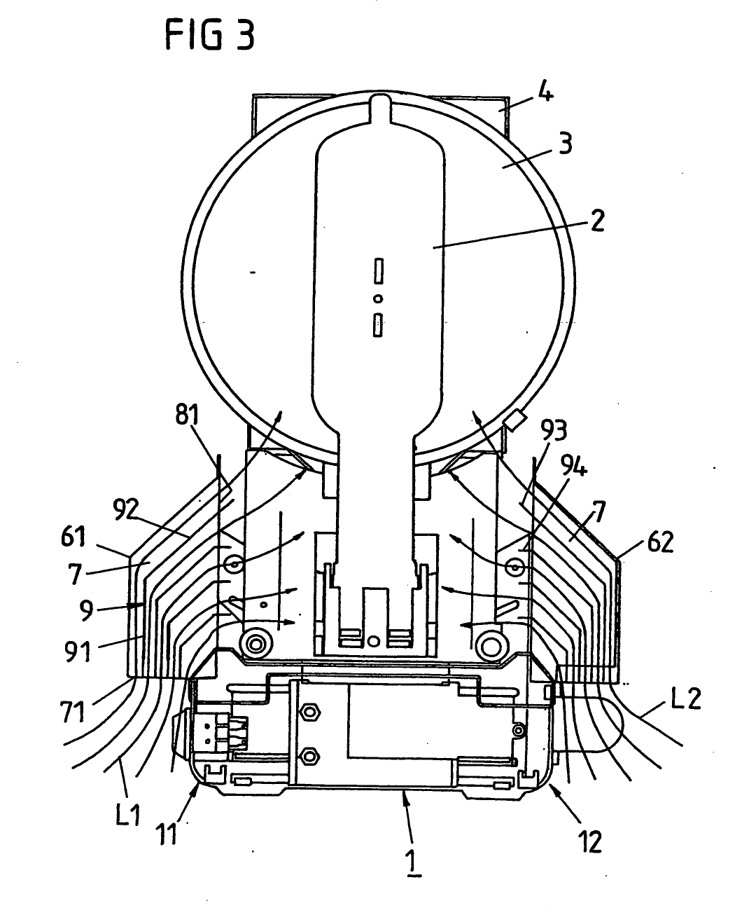

FIG. 3 shows a cross-section through the spotlight housing according to FIG. 1.

FIG. 1 shows a perspective view of a part of a spotlight with a lower part of a spotlight housing 1 in which are mounted a light source 2 which is fitted into a light source socket 5 connected to the spotlight housing 1, as well as a reflector 3 which is connected to a reflector holder 4 which is likewise fixed on the spotlight housing 1. The light source 2, which is designed as a lamp or burner, the reflector 3 and the reflector holder 4 are surrounded by an upper normally cylindrical spotlight housing part connected to the lower part of the spotlight housing 1 and at the front of which is mounted a cover element in the form of a glass disc or lens and whose end opposite the cover element is closed. The upper spotlight housing part is normally profiled in order to enlarge the heat-dissipating surface area.

The lower spotlight housing 1 is substantially square and has two parallel side walls 11, 12, a front and back side wall 13, 14 as well as an underneath side 15. The lower spotlight housing 1 is connected to the upper spotlight housing part (not shown) through several connecting elements on the front and back side walls 13, 14 and the side walls 11, 12.

In order to discharge the infra red radiation emitted by the light source 2 the spotlight housing 1 has several ventilation shafts 61 to 63 as well as ventilation shafts 64, 65, which can be seen in FIG. 2, and through which cooling air is directed into the interior of the spotlight housing 1. The cooling air passes through the air inlet apertures 71 to 73 (FIGS. 2 and 3) of the ventilation shafts 61 to 65 outside of the spotlight housing 1 to air outlet apertures 81 to 83 opening into the inside of the spotlight housing 1, of which the air outlet aperture 83 of one of the ventilation shafts can be seen in the perspective view shown in FIG. 1.

Further details of the configuration of the ventilation shafts 61 to 65 as well as the cooling air guide can be seen from the longitudinal sectional view in FIG. 2 through the spotlight housing 1 according to FIG. 1 and from the cross-sectional view illustrated in FIG. 3 through the spotlight housing 1 according to FIG. 1.

FIG. 2 shows in the longitudinal section of the spotlight housing 1 a ventilation shaft 63 at the front and a ventilation shaft 64 at the back, as well as a ventilation shaft 65 mounted on the underneath of the spotlight housing 1. The ventilation shaft 63 at the front and the ventilation shaft 64 at the back are inserted in the front wall 13 and back wall 14 of the spotlight housing 1 so that the air inlet apertures 72 are arranged running at an angle to the front wall 13 and back wall 14 outside of the surface of the front wall 13 and back wall 14 whilst the air outlet apertures 82 are arranged in the inside of the spotlight housing 1 and run substantially parallel to the path of the front wall 13 and back wall 14.

The ventilation shaft 65 provided on the underneath 15 of the spotlight housing 1 is integrated into the underneath 15 of the spotlight housing 1 so that the air inlet aperture 73 of the ventilation shaft 65 lies flush with the wall face of the underneath 15 whilst the air outlet aperture 83 projects into the inside of the spotlight housing 1 and is arranged there adjacent the light source 2.

The cross-section through the spotlight housing 1 illustrated in FIG. 3 shows the ventilation shafts 61, 62 arranged on the side wall walls 11, 12 of the spotlight housing 1, with the air inlet apertures 71 protruding substantially vertically from the side walls 11, 12 whist the air outlet apertures 81 of the ventilation shafts 61, 62 adjoin the apertures in the side walls 11, 12.

The trapezoidal ventilation shafts 61, 62 can be formed as part of the side walls 11, 12 or are fitted or pushed in suitable manner onto the side walls 11, 12 provided with an aperture, or are connected to the side walls 11, 12 through screw or clip connections.

As can be seen from the sectional views through the spotlight housing 1 according to FIGS. 2 and 3 several ribs 7 are provided parallel to each other inside the ventilation shafts 61 to 65 where they are arranged at regular intervals to each other and to the side walls of the ventilation shafts 61 to 65. The light-absorbing ribs 7 are bent so that they have a first section 91 (FIG. 3) adjoining the air inlet aperture 71 to 73 as well as a second section 92 adjoining the air outlet aperture.

As can be seen from the cross-sectional view according to FIGS. 2 and 3, the ribs 9 can project beyond the air outlet apertures 81 and form there a bent air guide section 94, 96 or an air guide section 93, 95 which is aligned with the second section.

Through this shaping of the ribs 9 any wandering light is prevented from emerging from the inside of the spotlight housing 1 whilst a cooling air stream is ensured which causes a uniform distribution of the cooling air inside the spotlight housing 1 which is clearly shown from the air guide arrows L1 to L5 entered in the cross-sectional illustrations according to FIGS. 2 and 3.

FIG. 2 shows an air guide created by the ribs 9 in the front and rear ventilation shaft 63, 64 which is directed so that the cooling air stream L3, L4 is spread out uniformly staggered in the longitudinal direction of the spotlight housing 1 into its interior space. For this purpose the air guide sections 95, 96 of the ribs 9 provided in the region of the air outlet apertures 82 are designed so that the air guide section 95 of the rib adjacent the underneath 15 of the spotlight housing runs substantially horizontal following the second rib section whilst as the distance of the ribs 9 increases away from the underneath 15 of the spotlight housing the bending of the air guide sections 96 of the ribs becomes increasingly more pronounced.

The ventilation shaft 65 mounted on the underneath 15 of the spotlight housing 1 contains ribs 9 which open into the underneath 15 of the spotlight housing 1 at an angle to the plane of this underneath side 15 whilst they run substantially perpendicular to the underneath 15 of the spotlight housing 1 in the region of the air outlet aperture. Through a staggered arrangement in relation to the plane of the light source 2 a staggered air fan L5 is produced in front of the light source 2 which directs the infra red radiation emitted from the light source 2 directly to the upper part of the spotlight housing.

The ventilation shafts 61, 62 mounted on the side walls 11, 12 of the spotlight housing 1 have according to FIG. 3 several parallel ribs 9 whose sections 91 adjacent the air inlet aperture 71 run parallel to the side walls 11, 12 whilst the sections 92 of the ribs 9 leading to the air outlet aperture 81 run inclined to the side walls 11, 12 and are adapted to the angle of the top side of the wall of the ventilation shaft 61, 62.

The air guide sections 93, 94 of the ribs 9 provided in the region of the air outlet apertures 81 are likewise aligned so that an effective distribution of the cooling air flows L1, L2 is produced. For this purpose the upper rib has a section 93 aligned flush with the second section 92 of the rib 9 whilst the ribs underneath have a still bent section 94 as air guide section which protrudes substantially perpendicular from the cross sectional face of the air outlet aperture 81.

The air guide arrows L1, L2 of the cooling air entered in FIG. 3 show the air stream which is created through this shaping and arrangement of the ribs 9 and ventilation shafts 61, 62 and which is spread out uniformly over the cross-sectional surface area of the spotlight housing 1 so that the different regions inside the spotlight housing 1 are uniformly surrounded with the cooling air.

It is important in the design and arrangement of the ribs 9 in the ventilation shafts 61 to 65 that there is no cascading of the ventilation ducts 7 and thus heating which increases upwards from the bottom in the region of the air outlet apertures but that cooling air introduced from outside of the spotlight housing 1 is discharged through the separate ventilation ducts 7 to each region of the air outlet apertures of the ventilation shafts 61 to 65.

1. Spotlight more particularly a stage, studio, film and/or television spotlight, with a light source and a spotlight housing surrounding the light source and provided with a translucent cover element,
characterised in that
at least one wall (11 to 15) of the spotlight housing (1) has a ventilation shaft (61 to 65) with ventilation ducts (7) separated from each other.

2. Spotlight according to claim 1, characterised in that the ventilation shaft (61 to 65) is integrated in the housing wall (10 to 15) of the spotlight housing (1).

3. Spotlight according to claim 1, characterised in that the ventilation shaft (61 to 65) is fitted onto an aperture of the wall (11 to 15) of the spotlight housing (1) and is connected to the housing wall (11 to 15).

4. Spotlight according to claim 1, characterised in that the ventilation shaft (61 to 65) is inserted into an aperture in the wall (11 to 15) of the spotlight housing (1).

5. Spotlight according to at least one of the preceding claims characterised in that the ventilation shaft (61, 62) has an air outlet aperture (81) opening into one or more apertures of the housing wall (11, 12) of the spotlight housing (1) and an air inlet aperture (71) protruding from the wall (11, 12) of the spotlight housing (1).

6. Spotlight according to at least one of the preceding claims, characterised in that the ventilation shaft is inserted into the wall (13, 14) of the spotlight housing (1) so that the air inlet aperture (72) protrudes from the wall (13, 14) of the spotlight housing (1) and the air outlet aperture (82) projects into the inside of the spotlight housing (1).

7. Spotlight according to at least one of the preceding claims characterised in that the ventilation shaft (65) is integrated into the wall (15) of the spotlight housing (1) so that the air inlet aperture (73) closes substantially flush with the housing wall (15) and the air outlet aperture (83) is mounted inside the spotlight housing (1).

8. Spotlight according to at least one of the preceding claims, characterised by ventilation ducts (7) separated from each other by means of ribs (9).

9. Spotlight according to claim 8, characterised in that the ribs (9) are made of a light-absorbing material and/or a light-absorbing colour and/or have light-absorbing shaping.

10. Spotlight according to claim 8 or 9, characterised in that the ribs (9) are designed and arranged in the ventilation shaft (61 to 65) so that the cooling air supplied through the ventilation shaft (61 to 65) is active in different regions inside the spotlight housing (1).

11. Spotlight according to one of claims 8 to 10, characterised in that the ribs (9) are arranged at substantially regular intervals relative to each other and to the wall of the ventilation shaft (61 to 65).

12. Spotlight according to at least one of the preceding claims, characterised in that the ribs (9) inside the ventilation shaft (61 to 65) have at least one bent or deflected area.

13. Spotlight according to at least one of the preceding claims, characterised in that the ribs (9) at the side of the air inlet aperture (71 to 73) and/or air outlet aperture (81 to 83) are arranged perpendicular to the air inlet aperture (71 to 73) and/or air outlet aperture (81 to 83).

14. Spotlight according to at least one of the preceding claims, 8 to 12 characterised in that the ribs (9) at the side of the air inlet aperture (71 to 73) and/or air outlet aperture (81 to 83) are arranged at an angle to the air inlet aperture (71 to 73) and air outlet aperture (81 to 83).

15. Spotlight according to at least one of the preceding claims 8 to 14, characterised in that the ribs (9) at the air outlet aperture (81 to 83) have an air guide plate (94) which projects beyond the air outlet aperture (81 to 83).

16. Spotlight according to at least one of the preceding claims, characterised in that the ventilation shafts (61, 62) are arranged on both side walls (11, 12) of the spotlight housing (1).

17. Spotlight according to at least one of the preceding claims, characterised in that the ventilation shafts (63, 64) are arranged on the front and back side walls (13, 14) of the spotlight housing (1).

18. Spotlight according to at least one of the preceding claims, characterised in that at least one ventilation shaft (65) is mounted on the underneath (15) of the spotlight housing (1).

19. Spotlight according to claim 18, characterised in that the air outlet aperture (83) of the ventilation shaft (65) mounted on the underneath (15) of the spotlight housing (1) opens directly adjacent the light source (2) or light source socket (5) into the inside of the spotlight housing (1).
